(19) United States
(12) Patent Application Publication
(10) Pub. No.: US 2018/0349338 A1
(43) Pub. Date: Dec. 6, 2018

(54) VISUALIZATION BETWEEN INPUT TABLE AND PIVOTED RESULTS

(71) Applicant: Microsoft Technology Licensing, LLC, Redmond, WA (US)

(72) Inventors: Chairy Chiu Ying CHEUNG, Redmond, WA (US); Euan Peter GARDEN, Bellevue, WA (US)

(21) Appl. No.: 15/612,143

(22) Filed: Jun. 2, 2017

(51) Int. Cl. G06F 17/24; G06F 3/0482; G06F 3/0484

(52) U.S. Cl. CPC G06F 17/245; G06F 3/04845; G06F 3/0482

(57) ABSTRACT

A user interface that concurrently shows both the input tabular data in an input portion and the result of pivot operation(s) derived from the input tabular data in a results portion. Association visualizations show associations between the input tabular data and the result of the pivot operation(s). For instance, a column of the input table may be visually associated with rows or columns of the result of the pivot operation. As another example, aggregated data may be visualized as associated with the corresponding input values from which the aggregated data was formed. Thus, a user may see how a pivot table or other result was constructed from input tabular data. Once the user selects an apply control, the input portion is deemphasized and the results portion is further emphasized, and association visualizations may be removed. Thus, the results portion can act as a preview of the pivot operation.

### BACKGROUND

Computing systems and associated networks have greatly revolutionized our world ushering in what is now commonly called the “information age”. The amount of accessible data has grown considerably with the rapid growth of database and crowd computing technologies. Much of the available data is structured in the form of tables. To make sense of tabular data, a variety of technologies have developed to enable different views on such tabular data. One such conventional technology is referred to as pivot tables, which are summaries of the original table in the form of a new table with rows and columns reorganized.

Rows in a pivot table are created from distinct values of a column of the original tabular data. Likewise, columns in a pivot table are created from distinct values of another column of the original tabular data. The content of the pivot table is created from aggregated values from yet another column of the original tabular data, where each entry represents some aggregated function (e.g., sum, count, average) of all values of the original data that corresponding to those the distinct values now labelled in the rows and columns. This creates a new way of looking at the original data, and can provide insights that are not intuitively seen from the input tabular data. This can be especially useful for large tables in which aggregation of data can significantly simplify the view on the data

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a user interface that concurrently shows both the input tabular data and the result of pivot operation(s) (e.g., a pivot table) derived from the input tabular data. In addition, one or more association visualizations show associations between the input tabular data and the result of the pivot operation(s). For instance, a column of the input table may be visually associated with rows or columns of the result of the pivot operation. As another example, aggregated data may be visualized as associated with the corresponding input values from which the aggregated data was formed. Thus, a user may see how a pivot table or other result was constructed from input tabular data.

In some embodiments, once the user selects an apply control, the input portion is deemphasized or even hidden, and the results portion is further emphasized. Furthermore, association visualizations may be removed. Thus, the results portion can act as a preview of the pivot operation, allowing the user to see associations between the original data and the pivot result table. Once the user has a sense that the results are as desired, the apply control may be selected. This tool may be especially helpful for large or enormous tables.

In the case of the results being a pivot table, when a column is about to be selected from the input tabular data for augmenting the pivot results, the number of unique values of that column may be identified, thereby giving the user a sense for how many columns may be added to the pivot results if the column is really selected from the input tabular data. This again, is helpful for very large input tabular data, in which the number of unique values in a given column may not be readily ascertainable, and yet has significant impact on what the resulting pivot results look like.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed;

FIG. 2 illustrates a user interface in accordance with the principles described herein, which includes an input portion that displays input tabular data, and a result portion that displays a pivot result of a pivoting operation on the input tabular data;

FIGS. 3 through 14 illustrate a first alternative of a first walkthrough example in which the pivoting operating is a distinct value pivot operation;

FIG. 3 is the beginning user interface of the first alternative of the first walkthough example, in which just the input tabular data is shown just prior to initiating the pivoting operation;

FIG. 4 shows a user interface that represents a user interfaced displayed upon initiation of a pivot preview operation;

FIG. 5 illustrates a user interface that is similar to the user interface of FIG. 4, except that now the branch ID rows of the input tabular data are further visually emphasized in response to the user selecting one of the columns;

FIG. 6 shows a user interface that is similar to the user interface of FIG. 4, except that now a user is in the process of interfacing with the column creation control by using a dragging gesture from the area of the transaction type column of the input tabular data into the column creation control;

FIG. 7 illustrates a user interface that shows the result of the column creation operation of FIG. 6, in which because there were two distinct values (deposit and withdrawal) of the transaction type column of the input tabular data, a deposit column and a withdrawal column are created in the pivot results;

FIG. 8 illustrates the user interface, which is similar to the user interface of FIG. 7, except that there has been a further change to the column creation control in which the user has desired to select yet a second column of the input table (resulting in a second drop down menu);

FIG. 9 illustrates the user interface, which is similar to the user interface of FIG. 8, except that the user has now selected the second drop down menu, exposing the possible columns of the input tabular data that may be selected;

FIG. 10 illustrates a user interface that shows a result of the user interface of FIG. 9, if the user were to select the transaction method column from the drop down menu of FIG. 9;

FIG. 11 shows a user interface that is similar to the user interface of FIG. 10, but shows a result of the interfacing with the aggregation creation control of FIG. 10;

FIG. 12 illustrates a user interface that is similar to the user interface of FIG. 11, except that the results of the interfacing with the correlated column control of FIG. 11 are shown;

FIG. 13 illustrates a user interface that is similar to the user interface of FIG. 12, except that now a visualized association between the selected aggregated value and its inputs is shown;

FIG. 14 illustrates a user interface that shows what appears if the user selects the apply control of FIG. 13, which completes the first alternative of the first walkthough example;

FIGS. 15 through 18 illustrate a second alternative of a first walkthrough example in which the pivoting operating is a distinct value pivot operation;

FIG. 15 illustrates that the user might first select the columns to be used to create aggregated content, and then select the pivot control, rather than individually selecting the columns to be used to create the rows and columns of the pivot results;

FIG. 16 illustrates a user interface representing a result of the operation of FIG. 15;

FIG. 17 illustrates an alternative to FIG. 16 in which the input tabular data is not displayed at all;

FIG. 18 illustrates that upon selecting more options of FIG. 17, the user may be permitted again to see the user interface of FIG. 13, thereby allowing for full viewing of the visualized association, and further editing of the pivot results if desired;

FIGS. 19 through 21 illustrate a second walkthrough example in which the pivoting operating is an existing value pivot operation;

FIG. 19 illustrates a user interface in which the user selects the four columns of the pivot results in FIG. 14, which now being the input tabular data for the existing value operation;

FIG. 20 illustrates a user interface in which the columns of FIG. 19 that had values are given their own row; and

FIG. 21 illustrates a user interface that shows what appears if the user selects the apply control of FIG. 20, which completes the second walkthough example.

### DETAILED DESCRIPTION

At least some embodiments described herein relate to a user interface that concurrently shows both the input tabular data and the result of pivot operation(s) (e.g., a pivot table) derived from the input tabular data. In addition, one or more association visualizations show associations between the input tabular data and the result of the pivot operation(s). For instance, a column of the input table may be visually associated with rows or columns of the result of the pivot operation. As another example, aggregated data may be visualized as associated with the corresponding input values from which the aggregated data was formed. Thus, a user may see how a pivot table or other result was constructed from input tabular data.

In some embodiments, once the user selects an apply control, the input portion is deemphasized or even hidden, and the results portion is further emphasized. Furthermore, association visualizations may be removed. Thus, the results portion can act as a preview of the pivot operation, allowing the user to see associations between the original data and the pivot result table. Once the user has a sense that the results are as desired, the apply control may be selected. This tool may be especially helpful for large or enormous tables.

In the case of the results being a pivot table, when a column is about to be selected from the input tabular data for augmenting the pivot results, the number of unique values of that column may be identified, thereby giving the user a sense for how many columns may be added to the pivot results if the column is really selected from the input tabular data. This again, is helpful for very large input tabular data, in which the number of unique values in a given column may not be readily ascertainable, and yet has significant impact on what the resulting pivot results look like.

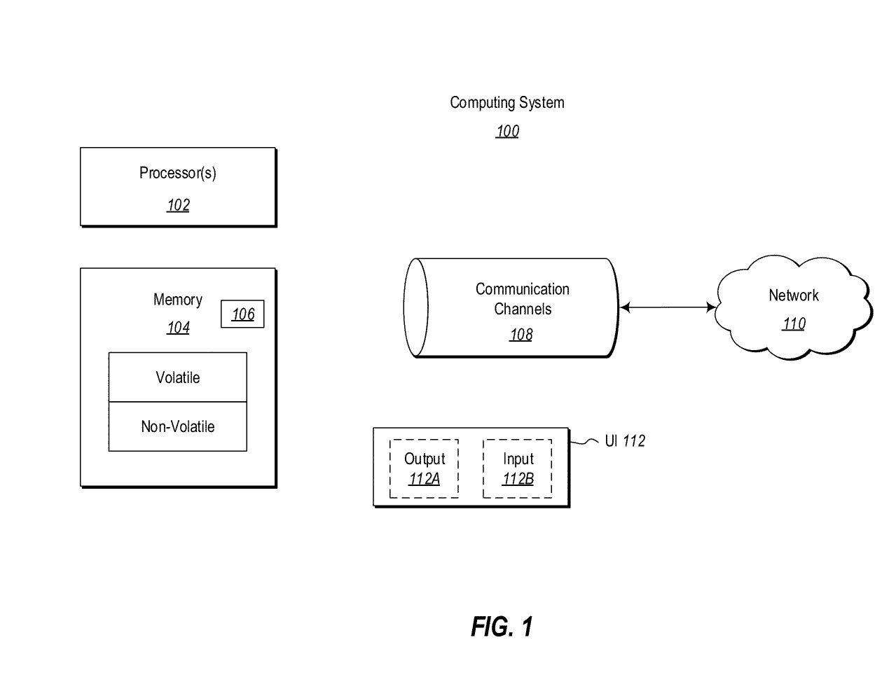

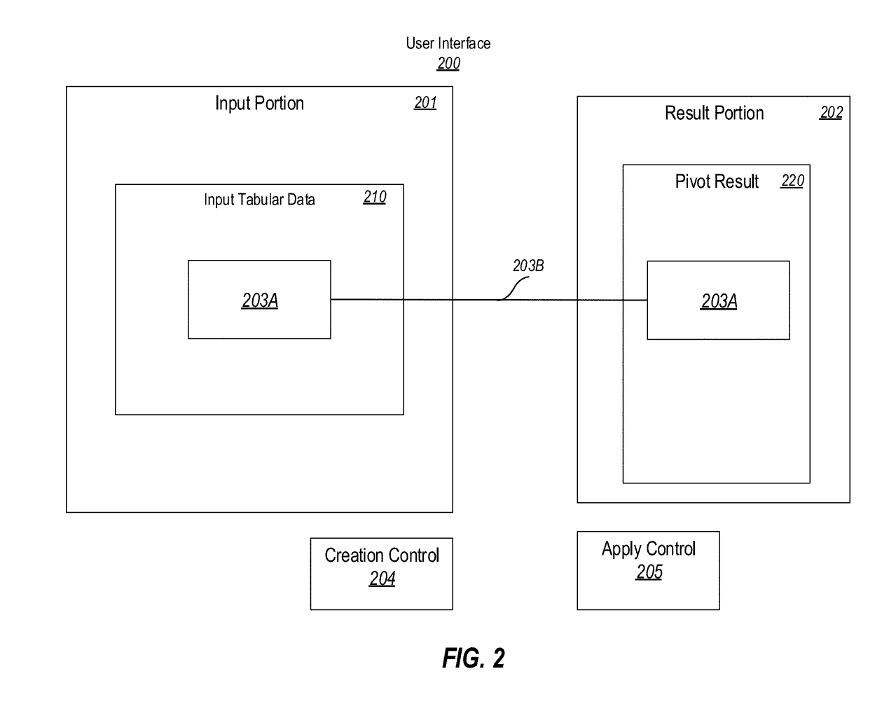

Because the principles described herein operate in the context of a computing system, a computing system will be described with respect to FIG. 1. Then, the user interface and mechanisms for interacting with a user will be described with respect to FIGS. 2 through 21.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the term “component” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, virtual reality, and so forth. Examples of input mechanisms 112B might include, for instance, microphones, touchscreens, holograms, virtual reality, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

FIG. 2 illustrates a user interface 200 in accordance with the principles described herein. The user interface 200 includes an input portion 201 that displays input tabular data 210 such as a table, and a result portion 202 that displays a pivot result 220 of a pivoting operation on the input tabular data. The pivot result 220 is also in tabular form. In the examples that follow, the pivoting operations will be referred to as a pivot (or “distinct value pivot operation”), and an unpivot (or an “existing value pivot operation”).

The user interface 200 also displays at least association between at least one section of the input tabular data 210 and at least one section of the pivot result 220. For instance, in FIG. 2, the associations are illustrated as association 203A and 203B. The association 203A represents the association by providing visual similarities (e.g., color coding, or similar patterns) in the input tabular data 210 and the pivot result 220. The association 203B is a connector that actually shows a visual connector connecting a portion of the input tabular data 210 and the pivot result 220.

The user interface 200 also includes a creation control 204 for creating rows and/or columns of a pivot result from a column of the input tabular table. An apply control 205 operates to hide or at least deemphasize the input portion 201 of the user interface, and that emphasizes the result portion 202 of the user interface 200. More detailed examples of the user interface 200 of FIG. 2 will be described with respect to all subsequent drawings.

Two example user interface walkthroughs will now be described. In the first example user interface walkthrough which will first be described, the pivot operation is a distinct value pivot operation, also known as a pivot operation, in which a pivot table is created. In a distinct value pivot operation, pivot results (i.e., a pivot table) are created in which rows and/or columns of a pivot results are each created from each distinct value of a respective column or each distinct value combination of columns of the input tabular data. Furthermore, the pivot result show aggregation results for each distinct value of the respective column or columns of the input tabular data.

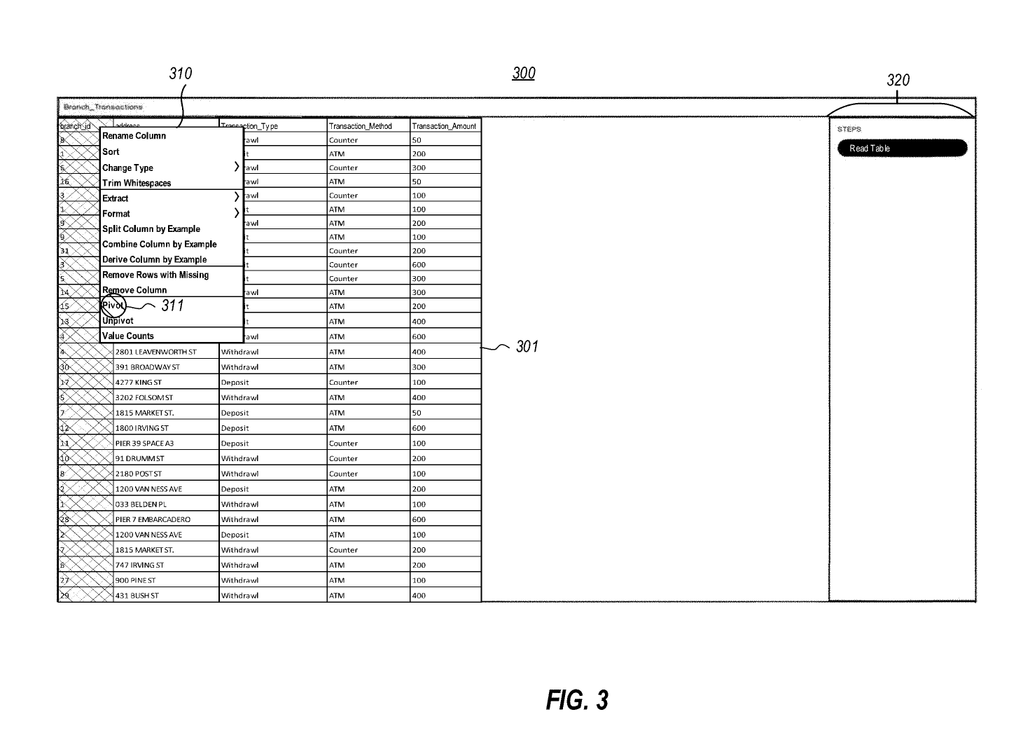

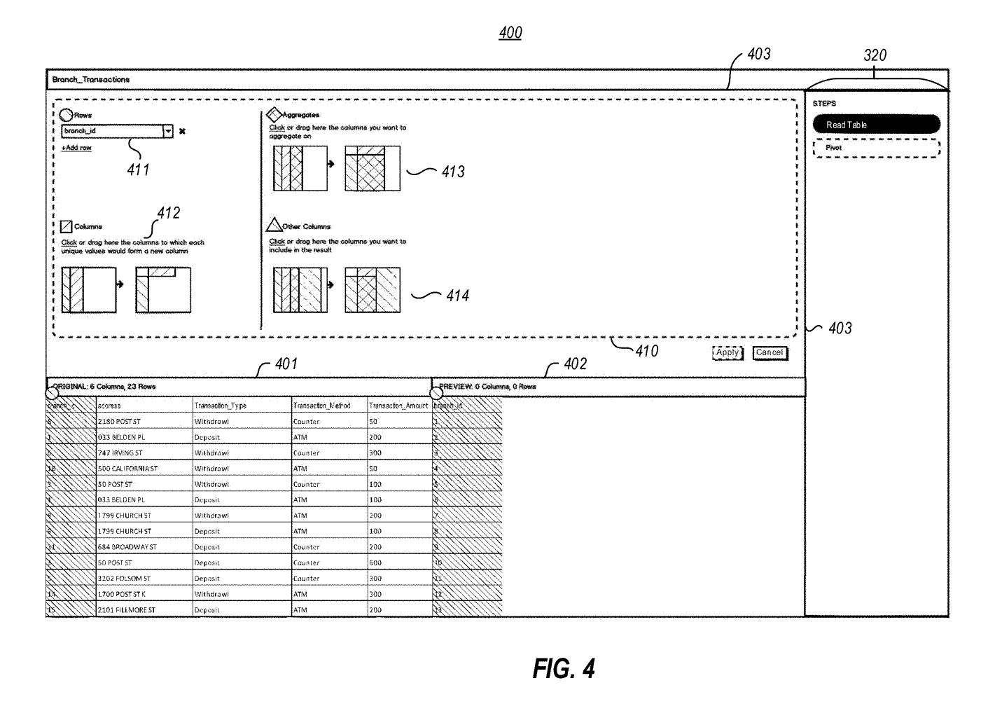

FIG. 3 is the beginning user interface 300 in the first walkthrough example. In this user interface 300, input tabular data is shown in the form of a branch transactions table 301. Thus, the branch transactions table 301 of FIG. 3 is an example of the input tabular data 210 of FIG. 2. A steps pane 320 identifies the steps taken in the walkthrough thus far. So far, as indicated by the steps pane 320, a table has been read. Each row of the branch transactions table 301 represents a branch transaction. From left to right, there is a column for the branch identifier, branch address, transaction type, transaction method, and transaction amount. Possible transaction types include deposits and withdrawals. Possible transaction methods including automated teller machine (ATM) and counter. In this first user interface 300, the user is about to initiate the walkthrough using an activated drop down menu 310 (e.g., by right clicking), and a pivot control 311 is further interfaced with to begin the pivot preview. A possible resulting user interface is shown in FIG. 4.

FIG. 4 shows a user interface 400 in which there is an input portion 401 and a result portion 402, which are examples of the input portion 201 and result portion 202, respectively, of FIG. 2. The steps pane 320 is updated to show that a pivot operation is being performed (as represented by the pivot operation element having a dashed-lined border). The input portion 401 shows the input tabular data (or in other words, the branch transactions table) in this first walkthrough example. A creation pane 403 provides a working pallet 410 that the user may interface with in order to create new columns and content in the results portion 402.

In this example, suppose that common color coding and pattern coding is used in order to show association between one or more columns of the input tabular data shown in the input portion 401 and one of more columns of the pivot results illustrated in the results portion 402. Because these are black and white drawings. Coloring will be symbolized through the use of pattern filling. For instance, note that the result portion 402 is already filled with one column, the branch ID column, which comes from the branch ID column of the tabular input data in the input portion 401. To show this association, both columns might be commonly colored in light red fill (represented by left-leaning hash marking in the walkthrough examples).

The creation pane 403 is an example of the creation control 204 of FIG. 2, and also provides prompts to the user for how to create results in the results portion 402. For instance, a row creation control 411 takes the form of a drop down menu. The user may select which column of the input tabular data is to be used to draw distinct values from in order to create the rows of the pivot results. In this case, by default, the branch ID column is selected, but a different column of the input tabular data may instead be selected in order to similarly create the rows by interfacing with the drop down menu control of the row creation control 411. If multiple columns are selected from the row creation control 411, then the rows in the pivot results of the result portion 402 may be cascaded. The number of rows may be dynamically updated as the input tabular data changes (e.g., to change the number of branch identifiers) and/or if the column of the input tabular data used to create the rows changes.

The user interface 400 also has an apply control 405 and a cancel control 406, which take the form of button controls. The apply control 405 is an example of the apply control 205 of FIG. 2. In the state of FIG. 2, the apply control 405 is not selectable (a state that is represented by the control have dashed-lined borders in the walk through examples). The cancel control 406 is selectable in FIG. 4, and may be used to cancel the entire pivot operation, returning to the user interface 300 of FIG. 3.

The creation pane 403 also includes a column creation control 412, an aggregation creation control 413, and a correlated column control 414. Each of these controls 412, 413 and 414 give a hint as to the color coding that will be used to show correlations between columns of the input tabular data and corresponding content of the pivot results.

For instance, green is represented by right-leaning hash marking in the walkthrough examples, and may be used (upon interfacing with the column creation control 412) to visually associated columns of the input tabular data from which unique values are taken to create columns in the pivot results of the results portion 402. Additionally, blue is represented by cross hash marking in the walkthrough examples, and may be used (upon interfacing with the aggregation creation control 413) to visually associate columns of the input tabular data which are used as input to an aggregation to create populated values of the results portion 402. Finally, yellow is represented by left-leaning dashed hash marking in the walkthrough examples, and may be used (upon interfacing with the correlated column creation control 414) to visually associate columns of the input tabular data which have (or are made to have) a one-to-one correlation with the rows of the pivot result in the result portion 402.

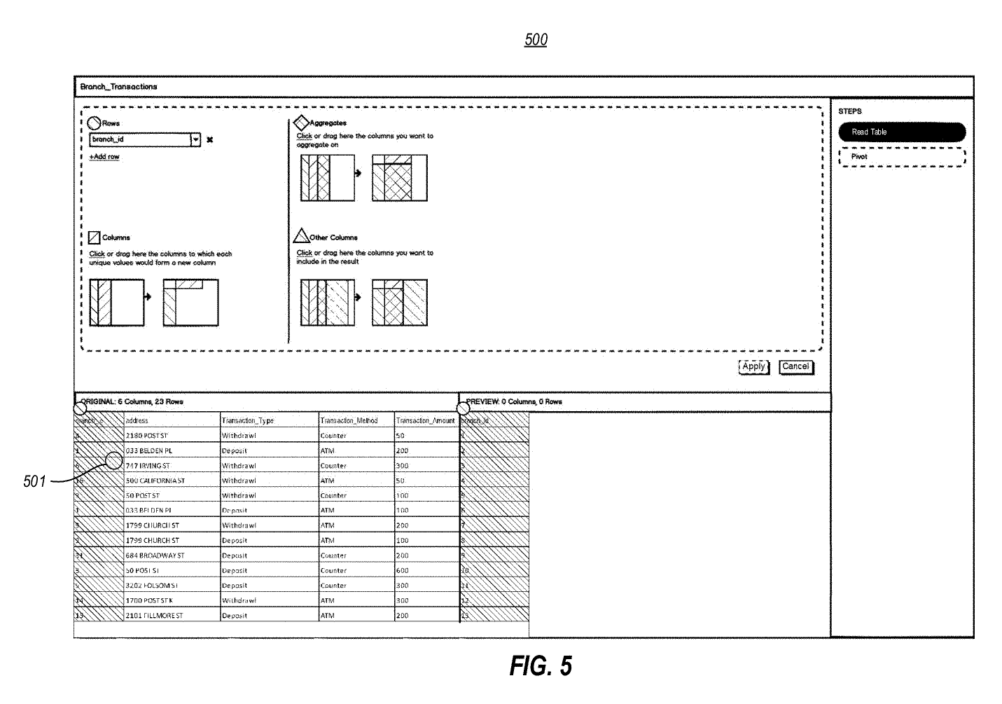

FIG. 5 illustrates a user interface 500 that is similar to the user interface 400 of FIG. 4, except that now the branch ID rows of the input tabular data are further visually emphasized in response to the user selecting one of the columns. For instance, in this example, the user has selected the branch ID column of the input tabular data (as represented by the circle 501). This might cause the red of branch ID columns to be made even darker red. This is represented in FIG. 5 by the left-leaning hash marking have a higher density. Thus, a user may select (e.g., hover over or click on) a portion of one of the pivot results or the input tabular data in order to quickly visually emphasize where that selected portion comes from (in the case of selecting the pivot results) or what that portion provides input to (in the case of selecting the input tabular data). Thus, the color coding represents an example in which the visual association remains constant when the pivot result and the input tabular data is not interfaced with, but which is emphasized when the respective portions of the pivot results or the input tabular data are interfaced with.

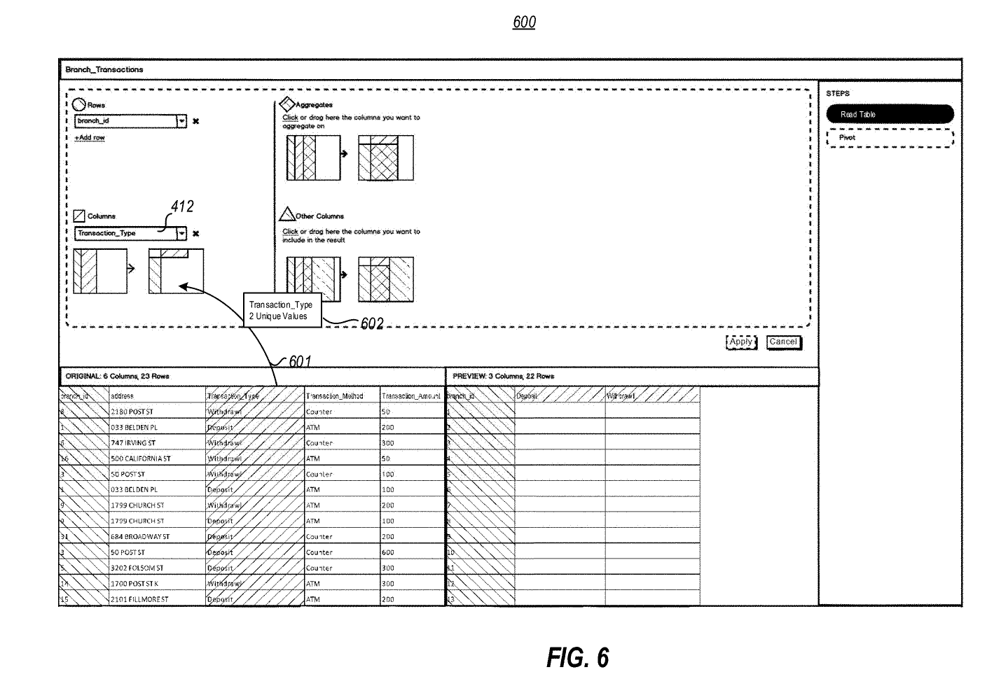

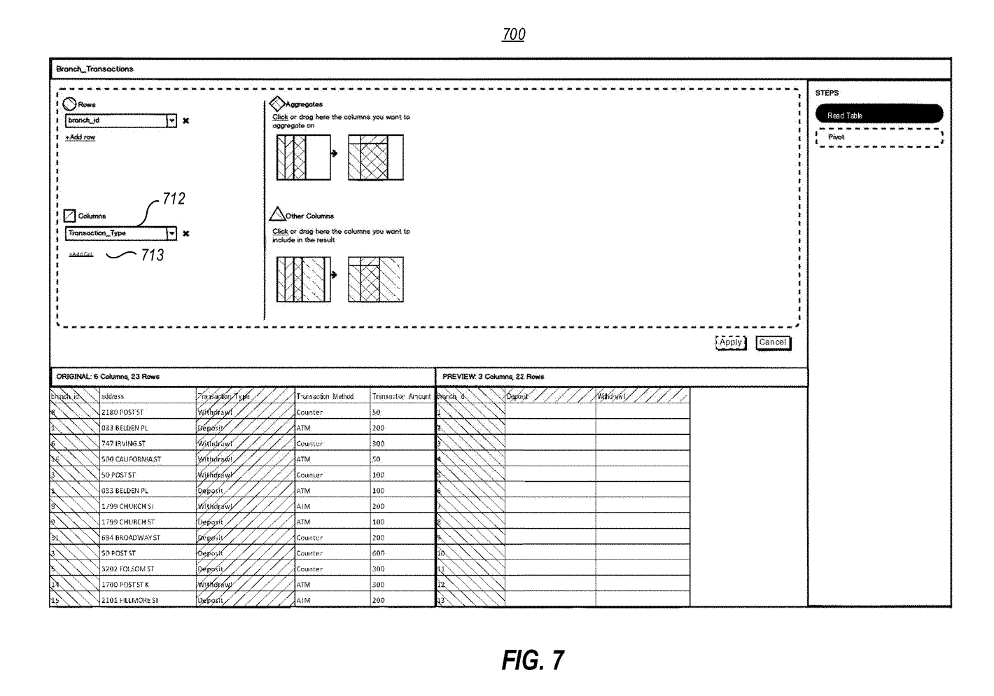

FIG. 6 shows a user interface 600 that is similar to the user interface 400 of FIG. 4, except that now a user is in the process of interfacing with the column creation control 412 by using a dragging gesture (as represented by arrow 601) from the area of the transaction type column of the input tabular data into the column creation control 412. The result is illustrated in FIG. 7, but note that for now, a unique values element 602 is displayed to the user, which tells the user how many unique (i.e., distinct) values are in that column (and thus how many columns will be created in the pivot results).

In this particular example, it is obvious that there are just two unique values, deposit and withdrawal, that are populated within this transaction type column. However, for large and/or unpredictable columns, it may be difficult to know ahead of time how many unique values are in that column. This unique values element 602 helps to forecast how many columns will be created in the pivot results by the column creation process. The user might wish to abandon or proceed with a column creation process based on the content of the unique values element 602. In the case of abandoning the column creation process, data processing may be preserved.

FIG. 7 illustrates a user interface 700 that shows the result of the column creation operation of FIG. 6. Because there were two distinct values (deposit and withdrawal) of the transaction type column of the input tabular data, a deposit column and a withdrawal column are created in the pivot results. The color association between these two columns is represented with green, as represented by the right-leaning hash marking. Selecting a green portion of either the input tabular data or the pivot results will result in visual emphasis of each green portion, thereby showing the user more clearly the relationship between the transaction type column of the input tabular data, and the deposit and withdrawal columns of the pivot results. Note that the column creation control 412 of FIG. 6 has now changed (as represented by the column creation control 712) to be a drop down menu in which the column of the input tabular data used to create columns of the pivot results may be altered.

The number of columns created in the pivot results may change if the number of distinct values of the transaction type column changes. For instance, if the original tabular data changes such that a third transaction type of “balance inquiry” is added. An addition “Balance Inquiry” column may be automatically added to the pivot result. Alternatively or in addition, if the use changes which column of the original input data is used to create the columns of the pivot result, the number of columns in the pivot results may change to accommodate the unique values in that newly selected column.

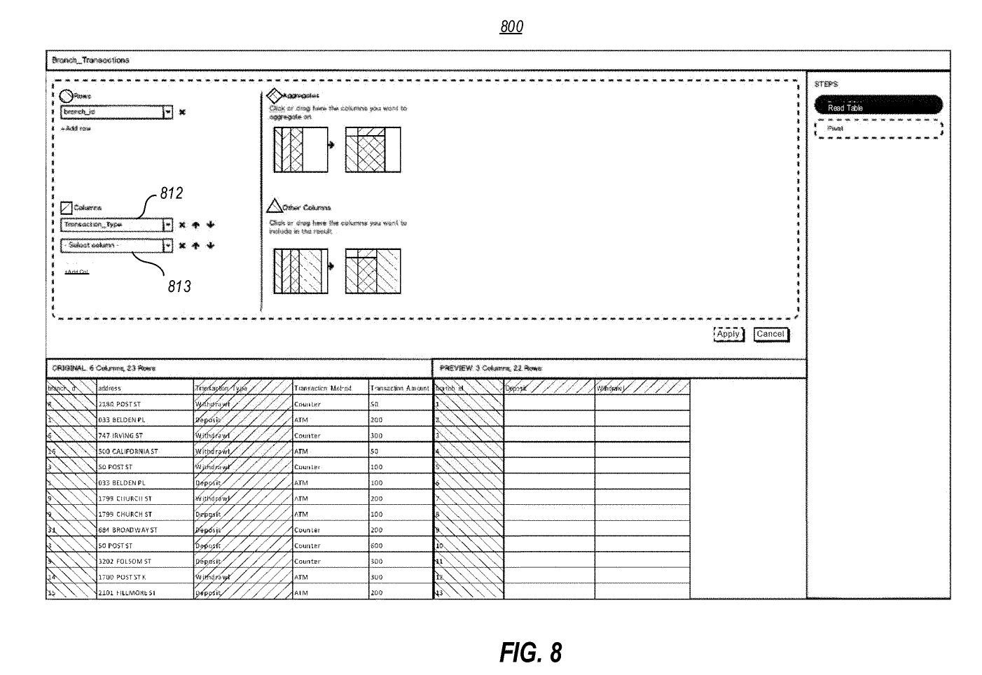

FIG. 8 illustrates the user interface 800, which is similar to the user interface 700 of FIG. 7, except that there has been a further change to the column creation control 712 (as represented by column creation control 812) in which the user has desired to select yet a second column of the input table (resulting in a second drop down menu). For instance, the user might have selected the “Add row” control 713 of FIG. 7. This results in a second drop down menu 813 in which the user may select the identity of an additional column of the input tabular data to use in creating columns of the pivot results.

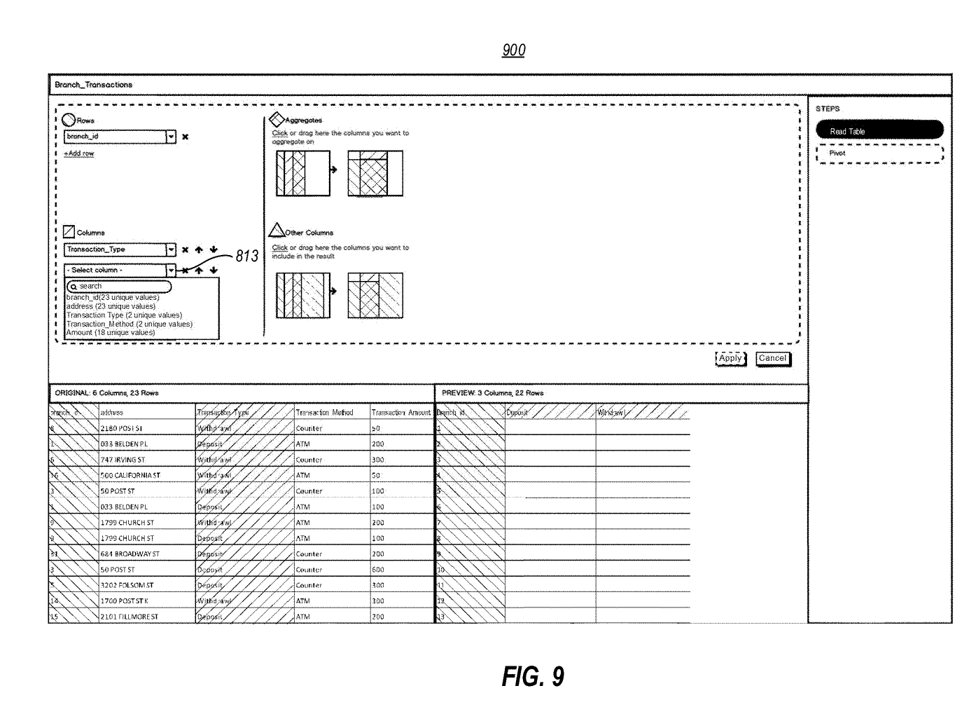

FIG. 9 illustrates the user interface 900, which is similar to the user interface 800 of FIG. 8, except that the user has now selected the second drop down menu 813, exposing the possible columns of the input tabular data that may be selected. Here again, the number of unique values of each column are displayed to the user, giving the user a sense for how complex the pivot results would become if the column of the input tabular data is selected. For instance, the transaction method column only has two unique values, whereas the transaction amount column has 18 unique values.

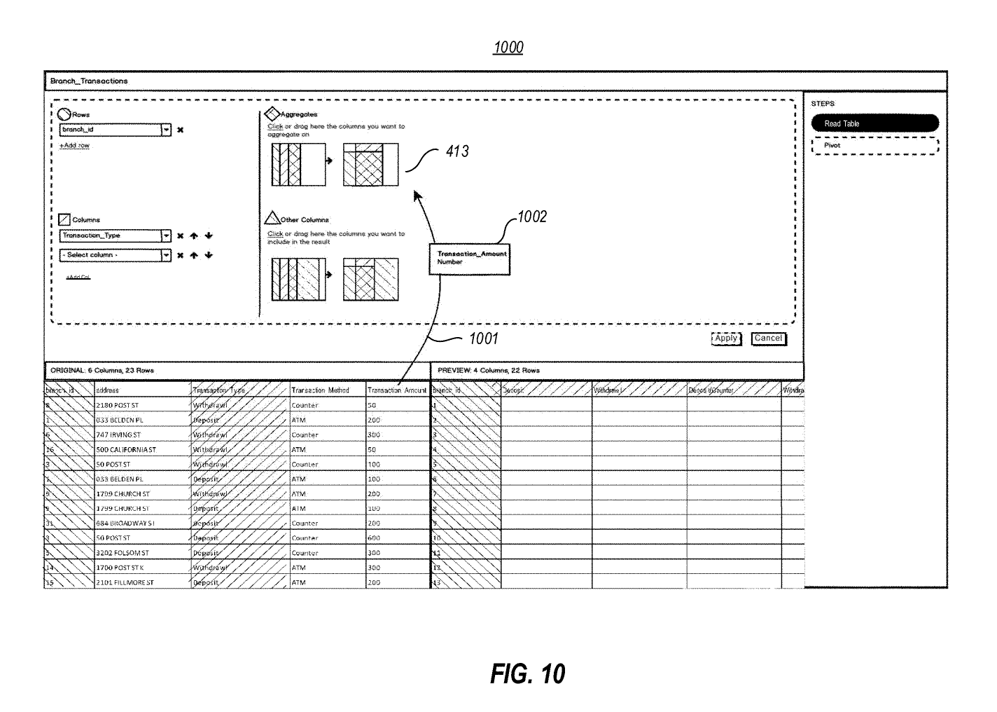

FIG. 10 illustrates a user interface 1000 that shows a result of the user interface 900 of FIG. 9, if the user were to select the transaction method column from the drop down menu 813 of FIG. 9. There are four unique values of the combination of the transaction type column and the transaction method column of the input tabular data. Those four unique combinations include Deposits/ATM, Deposits/Counter, Withdrawals/ATM, and Withdrawals/Counter. Accordingly, four columns are created in the pivot results, one for each unique combination. Again, the green color coding (left hash marking) illustrates the relationship between the two columns of the input tabular data and the four columns of the pivot results.

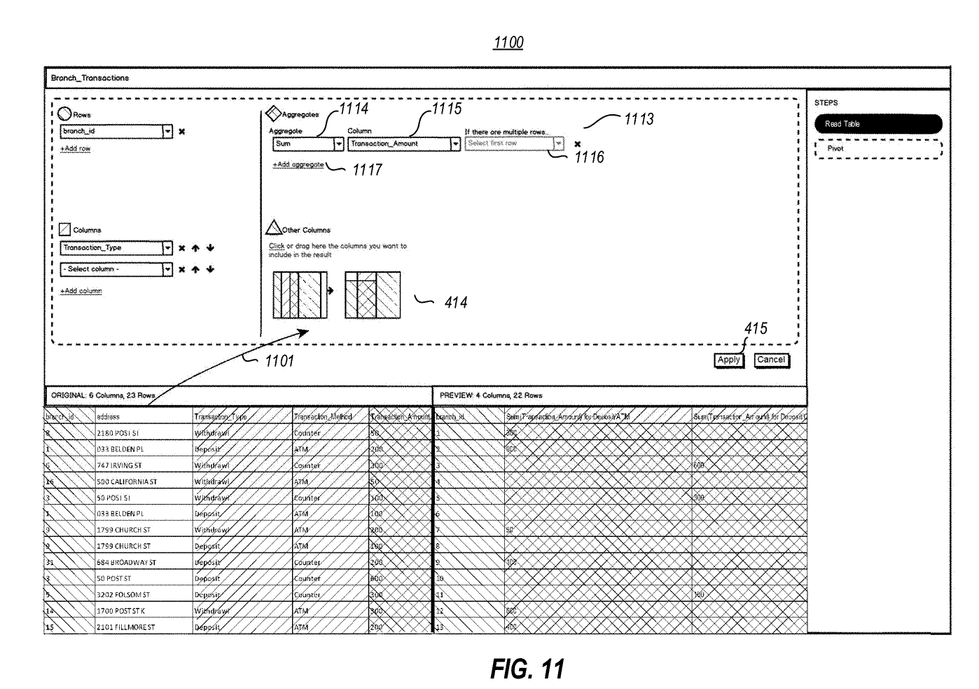

FIG. 10 also shows that now a user is in the process of interfacing with the aggregation creation control 413 by using a dragging gesture (as represented by arrow 1001) from the area of the transaction type column of the input tabular data into the aggregation column creation control 412. The result is illustrated in FIG. 11, but note that for now, an expected behavior element 1002 is displayed to the user, which tells the user an expected behavior of the aggregation. Here, the expected behavior element 1002 shows the column from which input values are taken to perform the aggregation, as well as the input data type.

FIG. 11 shows a user interface 1100 that is similar to the user interface 1000 of FIG. 10, but shows a result of the interfacing with the aggregation creation control (as represented by the arrow 1001) of FIG. 10. Now, the columns of the pivot results are populated with content. Furthermore, a relationship between the transaction amount column of the input tabular data and the content of the pivot results is shown via visualized associations. In this example, blue (represented with cross hatching) shows this relationship. Again, if the user were to hover over the blue area of either the input tabular data or the output tabular data, the relationship would be further emphasized (e.g., via dark blue coloring and/or with emphasized borders).

Furthermore, the aggregation creation control 413 of FIG. 10 has been altered, as represented by the new aggregation creation control 1113 of FIG. 11. The new aggregation creation control 1113 has an aggregation selection control 1114 in the form of a drop down menu for selection of the aggregation function to be applied to values of the input tabular data to create the content of the pivot results. In this case, “sum” is the aggregation function, but other aggregation functions might include averaging, finding the mean or median, finding the highest value, finding the lowest value, and so forth. The available and default aggregation function depends on the input data type of the column of the input tabular data on which aggregation is to be performed. An “add aggregation” control 1117 allows for the creation of new drop down menus that allow for additional aggregations to be created. For instance, the pivot results may be populated with two aggregations (e.g., a sum and an average).

The aggregation creation control 1113 also has a column selection control 1115 in the form of a drop down menu that allows the user to change the column of the input tabular data that is used in aggregation. The aggregation control 1113 further has a multiple row reconciliation control 1116 in the form of a drop down menu that allows that user to specify what to do if there are no aggregation functions specified in the aggregation selection control 1114. Possible options include 1) select the first row, 2) select the second row, 3) show as an error, and so forth.

The apply control 405 is now enabled because there is now content in the pivot table as a results of an aggregation function. In this case, there are both multiple row and multiple columns in the pivot results. However, both are not required in order for the apply control 405 to be selectable. At the stage of the first walkthrough, while the apply control 405 is selectable, it is not yet selected. Instead, as represented by arrow 1101, the user interfaces with the correlated column control 414 by selecting the address column as an additional column. Such additional columns are columns that tend to have a one-to-one correlation with the rows of the pivot results. For instance, in this case, the pivot results are rowed by branch ID. Since each branch ID has one and likely only one address, the address column is an appropriate selection for a correlated column.

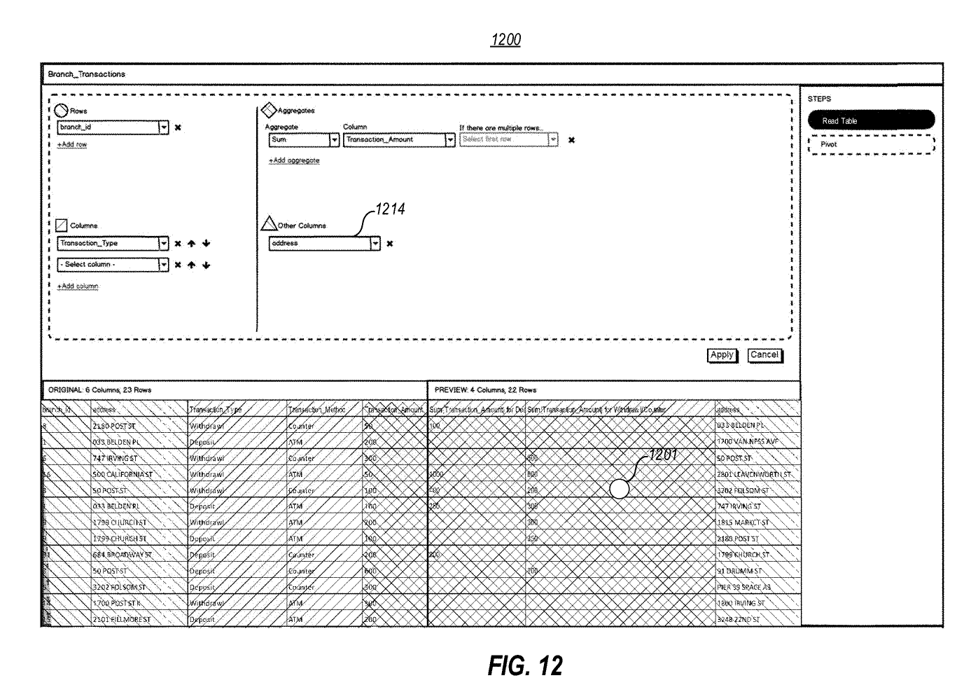

FIG. 12 illustrates a user interface 1200 that is similar to the user interface 1100 of FIG. 11, except that the results of the interfacing with the correlated column control 414 of FIG. 11 (as represented by arrow 1101) are shown. The address column is added to the pivot results. Furthermore, the address column of the input tabular data is shown as correlated with the address column of the pivot results. This could be via the use of a color, such as yellow, which is represented by rightward leaning dashed hash marking in the walk through examples. Furthermore, the correlated column selection control 414 has changed (as represented by the new column selection control 1214) in the form of a drop down menu, which allows the user to change the correlated column selection.

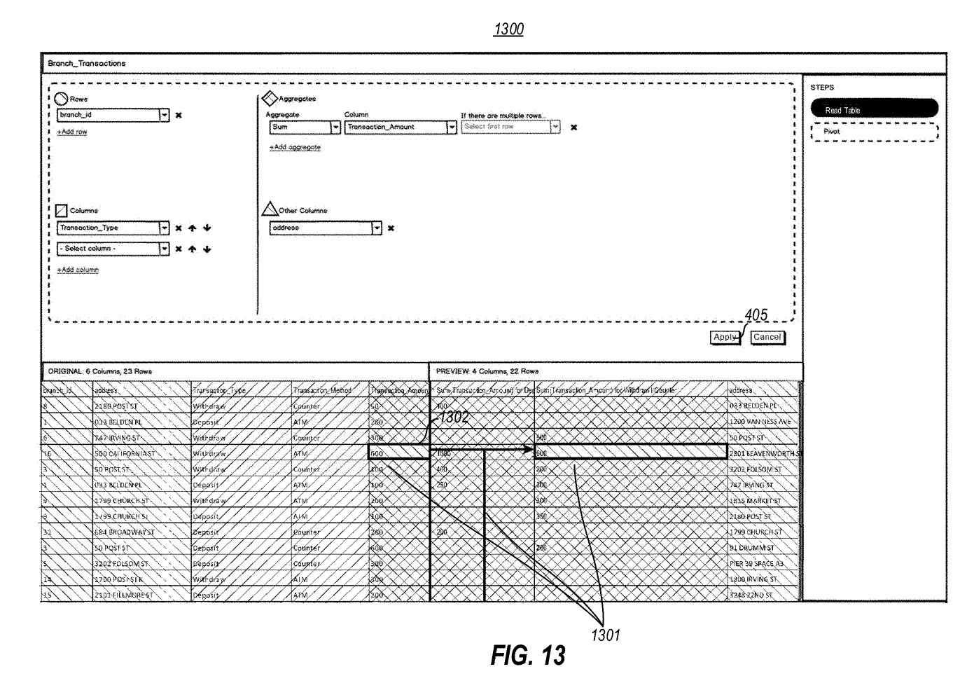

FIG. 12 also shows that the user has selected a portion of the content of the pivot results as represented by circle 1201. FIG. 13 illustrates a user interface 1300 that is similar to the user interface 1200 of FIG. 12, except that now a visualized association 1301 between the selected aggregated value and its inputs is shown. This visualization takes the form of a connector which physical shows a connection between the input(s) and the aggregated values. If the user has instead selected any of the inputs to that aggregated value from the input tabular data, a similar connected could be shown. For instance, upon selecting from area 1302, the same visualized association 1301 may appear. Thus, a user may quickly see the flow of an aggregation, and where an aggregated value comes from. Thus, in this case, the visualized association is created when the pivot result or the input tabular data is interfaced with.

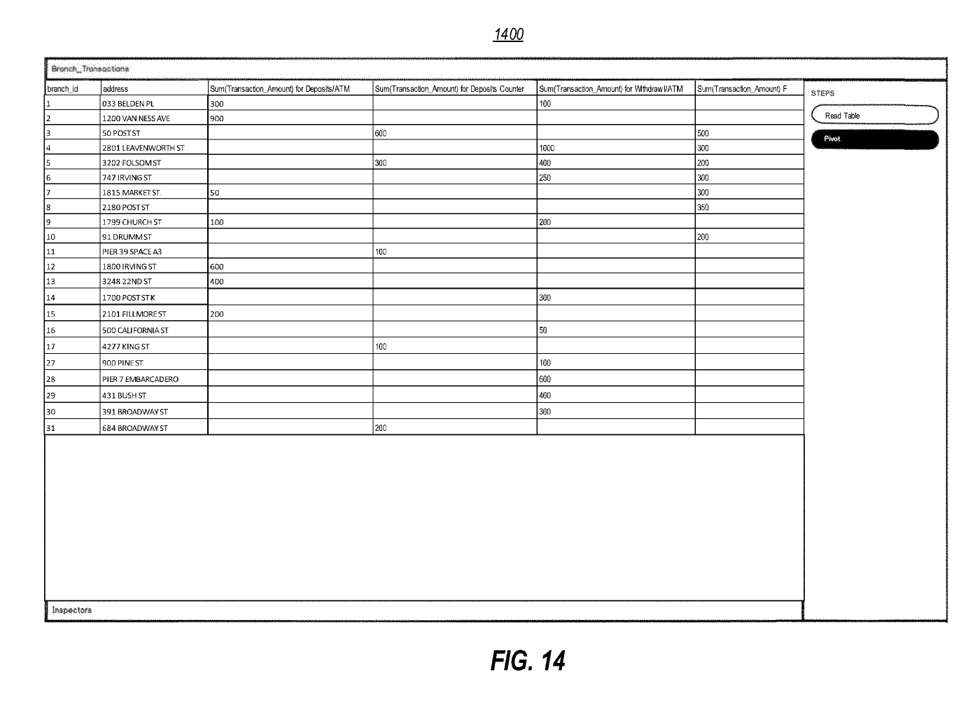

FIG. 14 illustrates a user interface 1400 that shows what appears if the user selects the apply control 405 of FIG. 13. Here, the input tabular data is deemphasized (and even hidden), whilst the pivot results are emphasized (in this case by being in a larger pane. Now, in the steps pane, the pivot operation is shown as complete. An alternative implementation of what FIG. 14 illustrate could be that a new dataflow (see “dataflows” on the left panel) is creating, containing the pivot result. One possible resulting view of “Shipping Stores” could either be the resulting table, or the data as in FIG. 3. As an example, the trigger command can also be split into two: “Pivot” and “Pivot and Fork”.

FIGS. 4 through 13 shown a first user interface walkthrough in which the user creates pivot results of FIG. 14 from an input tabular data of FIG. 3. In the first walkthrough, the visualized associations were displayed while creating the pivot results.

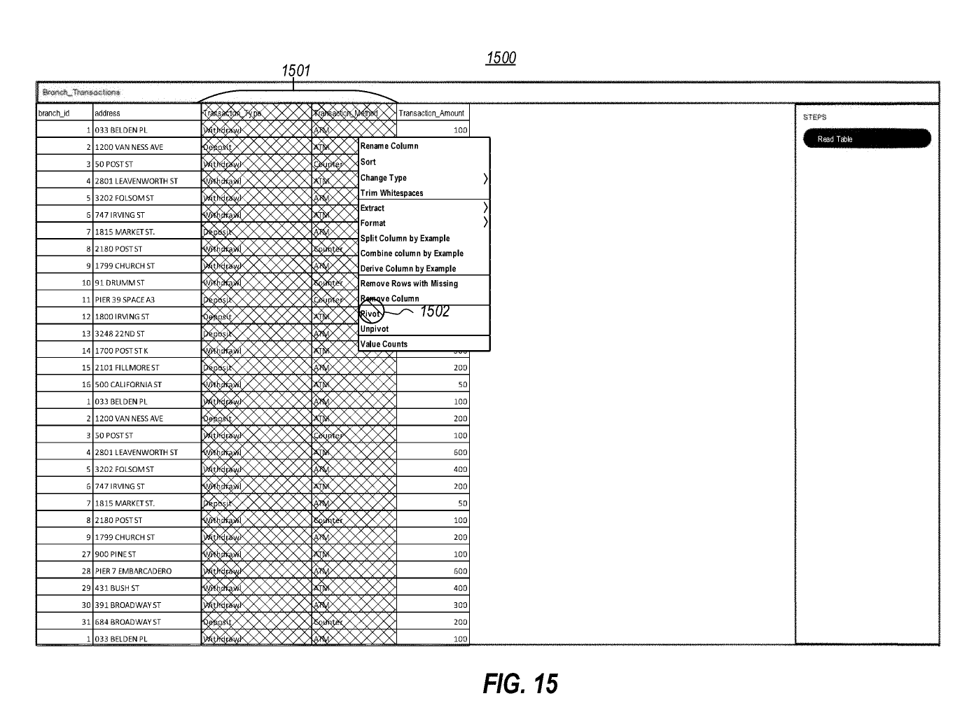

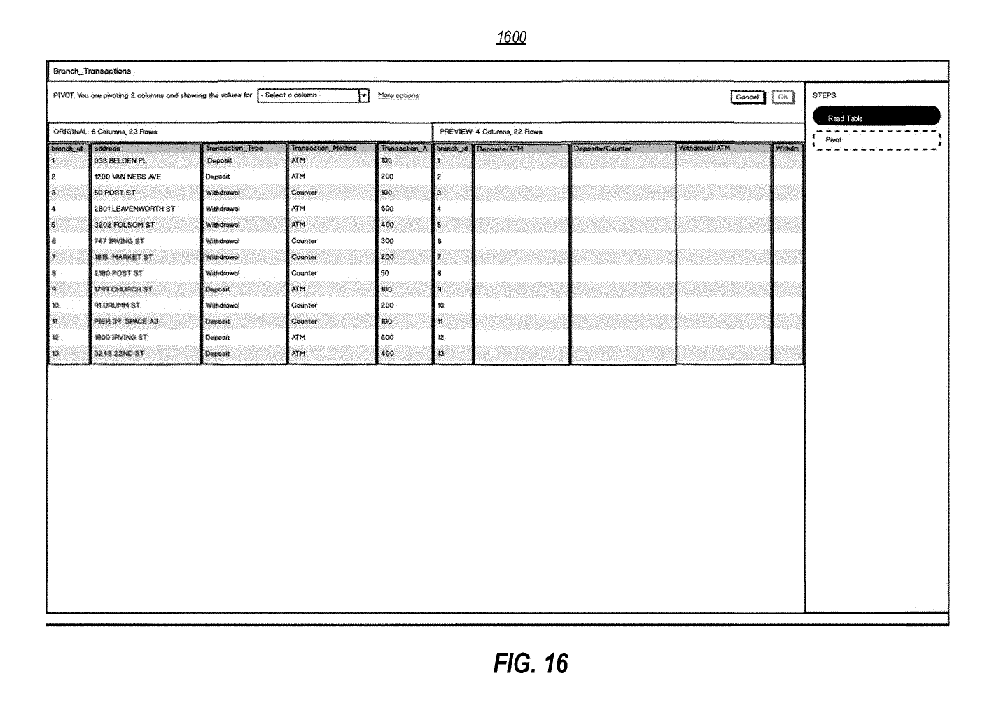

FIGS. 15 and 16 illustrate an alternative mechanism for more experienced users, in which the visualized associations are not used in creating the pivot results, but are displayed after creating the pivot results. As represented in FIG. 15, the user might first select the columns (e.g., columns 1501) to be used to create aggregated content, and then selects the pivot control 1502, resulting in the user interface of FIG. 16. The system then assumes that the first column is the only to create rows in the pivot table, and automatically creates columns in the pivot table for unique values of the selected columns. The trigger of the pivot transform is also different. Instead of selecting the branch ID, th user selects “Transaction_type” and “Transaction_method” before triggering the “pivot” command. These two columns are now in the “columns” section, and the “row” section is left empty. This is an alternative implementation to trigger and handles pivot. This way of selection could also apply to the first walkthrough where users go straight to the experience showing all the visualization.

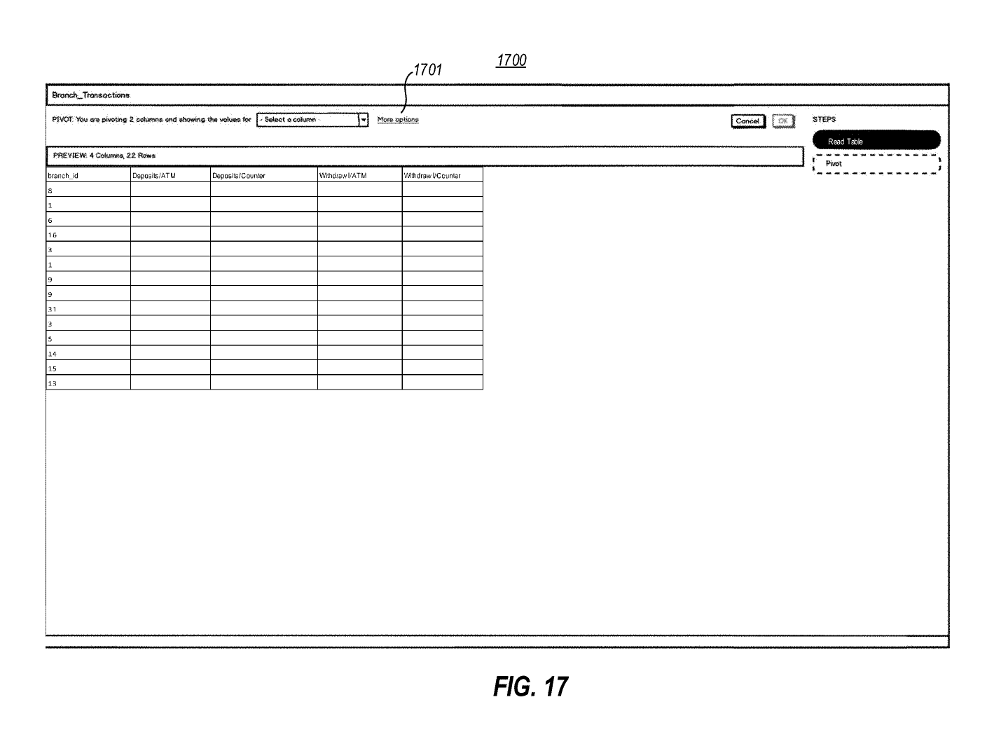

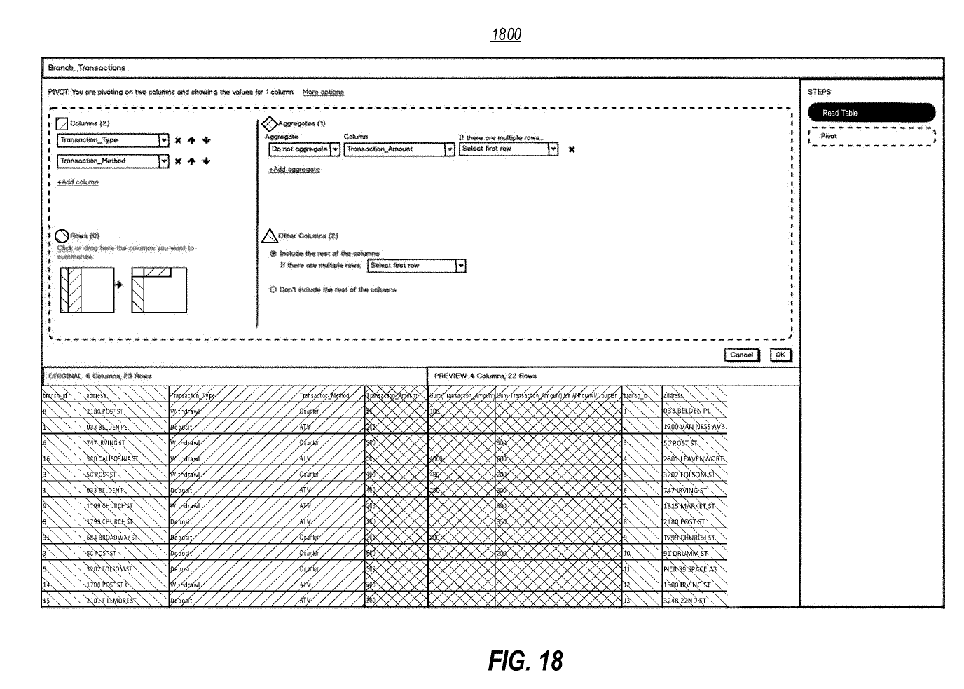

FIG. 17 illustrates an alternative to FIG. 16 in which the input tabular data is not displayed at all. FIG. 18 illustrates that upon selecting more options 1701 of FIG. 17, the user may be permitted again to see the user interface of FIG. 13, thereby allowing for full viewing of the visualized association, and further editing of the pivot results if desired.

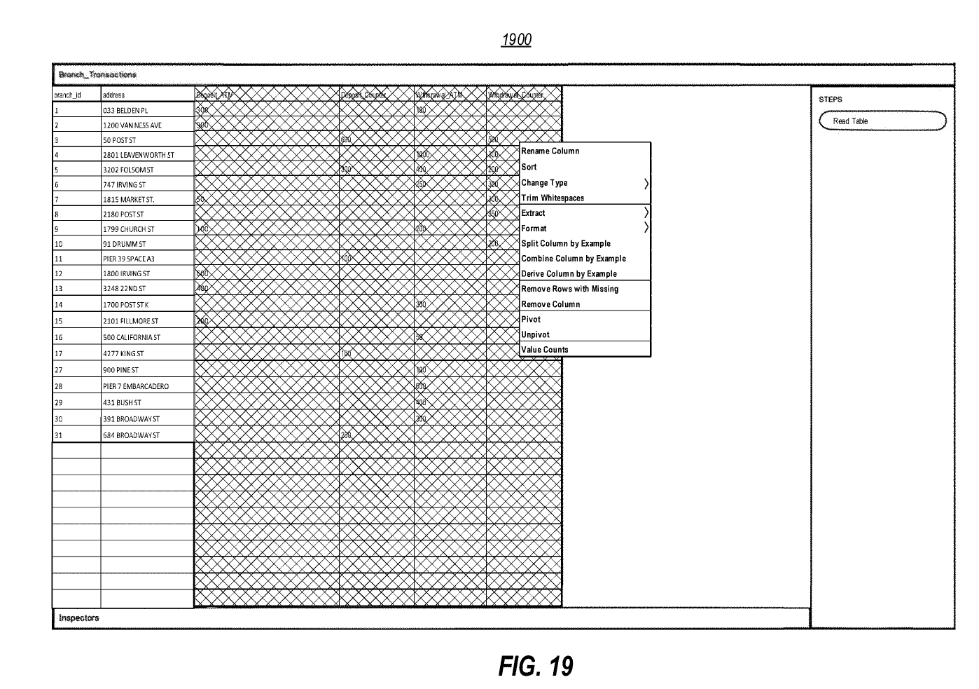

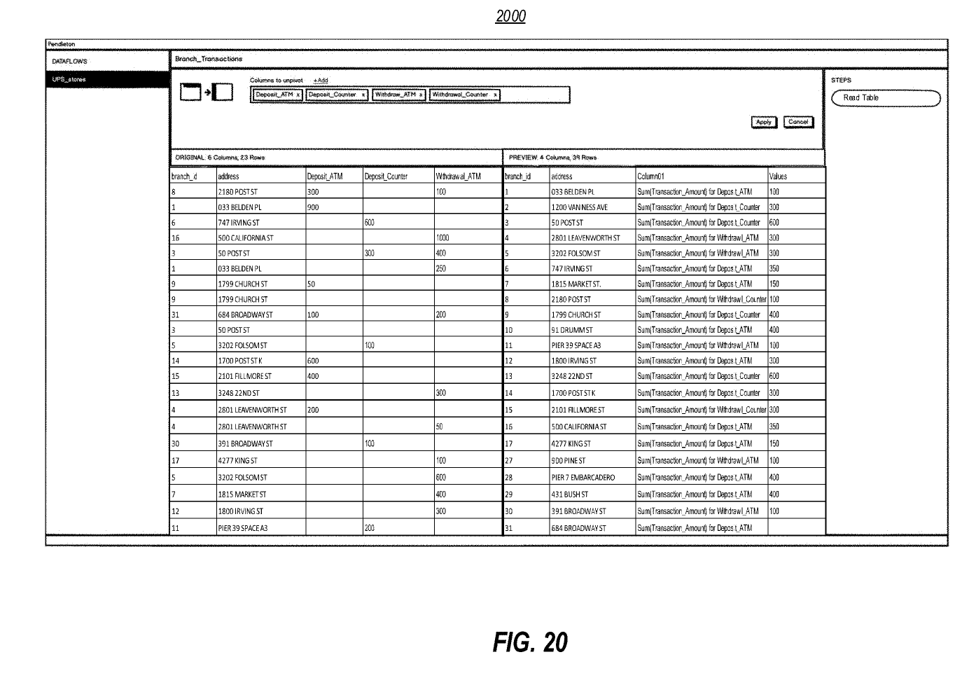

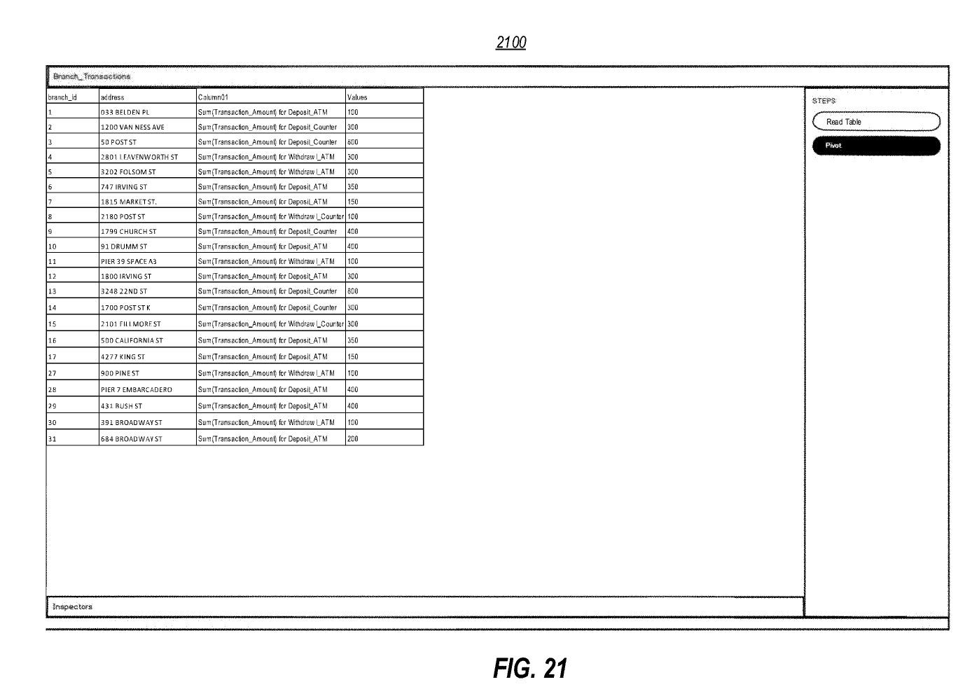

A further example of a pivot operation is an unpivot operation or an existing value pivot operation. In this operation, rows are created in the pivot result from each existing value across common multiple columns of each of multiple rows of the input tabular data. FIG. 19 illustrates a user interface in which the user selects the four columns of the pivot results in FIG. 14, which now being the input tabular data for this second pivot operation—the existing value operation. That said, the unpivot operation may be upon any data, and not just data that has been previously pivoted. FIG. 20 illustrates a user interface 2000 in which the columns that had values are given their own row. Upon selecting the apply control in FIG. 20, the user interface 2100 of FIG. 21 may appear.

Accordingly, the principles described herein provide for a user interface that allows for efficient creation and editing of pivot results from input tabular data. This allows pivot results to be created for even complex tables, in an efficient manner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computing system comprising:
one or more processors; and
one or more computer-readable media having thereon computer-executable instructions that are structured such that, when executed by the one or more processors, cause the computing system to formulate a user interface that comprises the following:
an input portion that displays input tabular data;
a result portion that displays a pivot result of a pivoting operation on the input tabular data; and
at least one association visualization that shows an association between at least one section of the input tabular data displayed in the input portion and at least one section of the pivot operation result displayed in the result portion.

2. The computing system in accordance with claim 1, the pivot operation comprising a distinct value pivot operation in which columns of a pivot result are each created from each distinct value of a respective column or each distinct value combination of columns of the input tabular data, one of the at least one association visualizations showing the association between one or more columns of the pivot result and one or more columns of the input tabular data.

3. The computing system in accordance with claim 2, the pivot result showing aggregation results for each distinct value of the respective column or columns of the input tabular data, another of the at least association visualizations showing the association between input values of the input tabular data and an aggregation result in the pivot result.

4. The computing system in accordance with claim 2, the distinct value operation also in which rows of a pivot result are each created from each distinct value of a respective column or each distinct value combination of columns of the input tabular data, another of the at least one association visualizations showing the association between one or more rows of the pivot result and one or more columns of the input tabular data.

5. The computing system in accordance with claim 4, the pivot result showing aggregation results, another of the at least association visualizations showing the association between input values of the input tabular data and an aggregation result in the pivot result.

6. The computing system in accordance with claim 1, the pivot operation comprising an existing value pivot operation in which rows are created in the pivot result from each existing value across common multiple columns of each of a plurality of rows of the input tabular data, one of the at least one association visualizations showing the association between the common multiple columns of the input tabular table and columns of the pivot result in which the values appear.

7. The computing system in accordance with claim 1, one or more of the at least one association visualization being a color coding.

8. The computing system in accordance with claim 1, one more of the at least one association visualization being a connector.

9. The computing system in accordance with claim 1, one or more of the at least one association visualization being a pattern coding.

10. The computing system in accordance with claim 1, one or more of the at least one association visualization remaining constant when the pivot result and the input tabular data is not interfaced with.

11. The computing system in accordance with claim 1, one or more of the at least one association visualization being further emphasized when the pivot result or the input tabular data is interfaced with.

12. The computing system in accordance with claim 1, one or more of the at least one association visualization being created when the pivot result or the input tabular data is interfaced with.

13. The computing system in accordance with claim 1, one or more of the at least one association visualizations being displayed while creating the pivot results by a user selecting one or more columns of the input tabular data.

14. The computing system in accordance with claim 1, one or more of the at least one association visualizations being displayed after creating the pivot results upon an association display control being interfaced with by a user.

15. The computing system in accordance with claim 1, further comprising a creation control for creating rows or columns of a pivot result from a column of the input tabular data, the control manifesting a number of distinct values of the column when the control is interfaced with.

16. The computing system in accordance with claim 1, the user interface further comprising an apply control that, when interfaced with by the user, hides the input portion of the user interface.

17. The computing system in accordance with claim 1, the user interface further comprising an apply control that, when interface with by the user, emphasizes the result portion of the user interface.

18. The computing system in accordance with claim 1, the user interface further comprising an apply control that, when interface with by the user, deemphasizes the input portion of the user interface, emphasizes the result portion of the user interface, and removes the at least one association visualization.

19. A method for associating input tabular data with pivot results created from performing a pivot operation on the input tabular data, the method comprising:
displaying an input portion that displays input tabular data;
displaying a result portion that displays a pivot result of a pivoting operation on the input tabular data at the same time as displaying the input portion; and
displaying at least one association visualization that shows an association between at least one section of the input tabular data displayed in the input portion and at least one section of the pivot operation result displayed in the result portion.

20. A computer program product comprising one or more computer-readable storage media having thereon computer-executable instructions that are structured such that, when executed by one or more processors of a computing system, cause the computing system to formulate a user interface that comprises the following:
an input portion that displays input tabular data;
a result portion that displays a pivot result of a pivoting operation on the input tabular data; and
at least one association visualization that shows an association between at least one section of the input tabular data displayed in the input portion and at least one section of the pivot operation result displayed in the result portion.
